(19) United States
(12) Patent Application Publication
(10) Pub. No.: US 2007/0097261 A1
(43) Pub. Date: May 3, 2007

(54) Region or frame based aspect ratio scaling

(76) Inventors: Brad Smith, Vancouver, WA (US); Carl J. Ruggiero, Tigard, OR (US); Todd Moyer, Aurora, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/588,063

(22) Filed: Oct. 25, 2006

Related U.S. Application Data
(60) Provisional application No. 60/730,247, filed on Oct. 25, 2005.

(51) Int. Cl. H04N 11/20

(52) U.S. Cl. 348/445

(57) ABSTRACT

An aspect ratio converter. The aspect ratio converter scales different segments of a video stream using different scaling functions. The aspect ratio converter can scale one region of a video frame using a first scaling function and scale another region of a frame of video using a second scaling function, different than the first scaling function.

### CROSS REFERENCE TO RELATED APPLICATIONS

This application claims priority to U.S. Provisional patent application No. 60/730,247, filed Oct. 25, 2005, the entirety of which is incorporated by reference for all purposes.

### BACKGROUND

A video format can be characterized by its aspect ratio, which is the ratio of the width of the displayed image to the height of the displayed image. Video can be formatted in a variety of different aspect ratios. For example, traditional television video is formatted with a 4:3 (i.e., 1.33:1) aspect ratio, meaning the video is formatted for display on a television screen that is 4 units wide and 3 units high. As other examples, High Definition Television is formatted with a 16:9 (i.e., 1.77:1) aspect ratio, and films are formatted with a variety of different aspect ratios, including 1.37:1, 1.66:1, 1.85:1, and 2.35:1. FIG. 1 shows these aspect ratios.

Most video display devices are designed to natively display video that is formatted with a particular aspect ratio. For example, most High Definition Televisions have 16:9 screens, on which 16:9 video can be displayed without modifying the aspect ratio. Furthermore, many display devices are designed to display video having nonnative aspect ratios. For example, a display device can display the video without changing its aspect ratio by framing the video with either horizontal bar(s) above and/or below the video image or vertical bar(s) on one or both sides of the video image. FIG. 2 schematically shows a 16:9 High Definition Television screen displaying 4:3 video by framing or letterboxing, the video with black bars to the left and right of the video. Likewise, FIG. 3 schematically shows a 16:9 High Definition Television screen displaying 2.35:1 video by framing the video with black bars above and below the video. While letterboxing allows video to be displayed in its native aspect ratio, much of the screen is wasted. For example, in FIG. 2, 25% of the screen is used to display black bars, and in FIG. 3, 24% of the screen is used to display black bars.

### BRIEF DESCRIPTION OF THE DRAWINGS

FIG. 1 shows a plurality of common video aspect ratios.

FIG. 2 shows video having a 4:3 aspect ratio displayed with letterboxing on a screen having a 16:9 aspect ratio.

FIG. 3 shows video having a 2.35:1 aspect ratio displayed with letterboxing on a screen having a 16:9 aspect ratio.

FIG. 4a shows 4:3 aspect ratio video natively displayed on a screen having a 4:3 aspect ratio.

FIG. 4b shows the 4:3 aspect ratio video of FIG. 4a linearly scaled for display on a screen having a 16:9 aspect ratio.

FIG. 4c shows the 4:3 aspect ratio video of FIG. 4a nonlinearly scaled for display on a screen having a 16:9 aspect ratio.

FIG. 5 schematically shows an aspect ratio converter that is configured to convert video having one aspect ratio to a different aspect ratio using two or more different scaling functions.

FIG. 6a shows an example 4:3 aspect ratio frame of video.

FIG. 6b shows the 4:3 aspect ratio frame of video from FIG. 6a scaled for display on a screen having a 16:9 aspect ratio. The top region of the frame is nonlinearly scaled and the bottom region of the frame is linearly scaled.

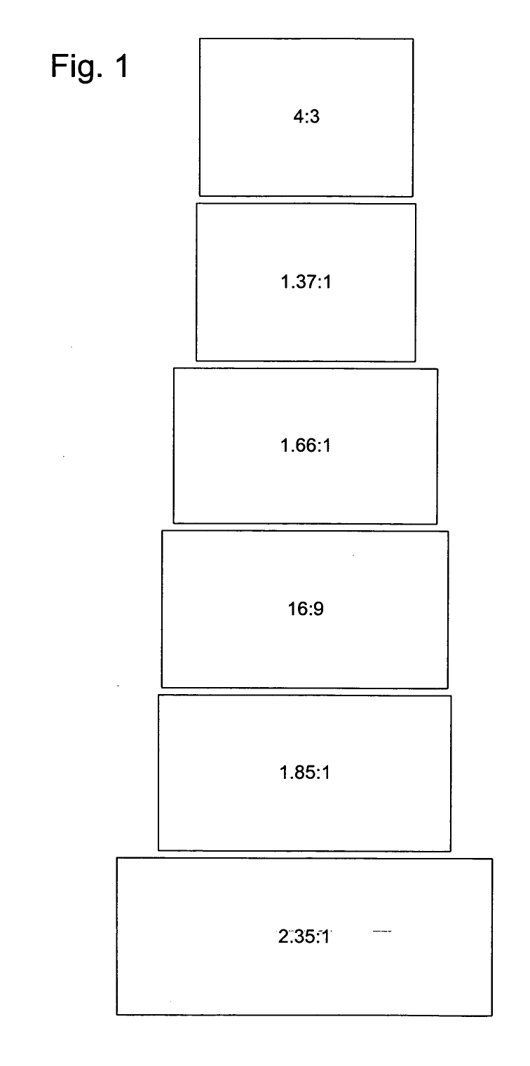

### WRITTEN DESCRIPTION

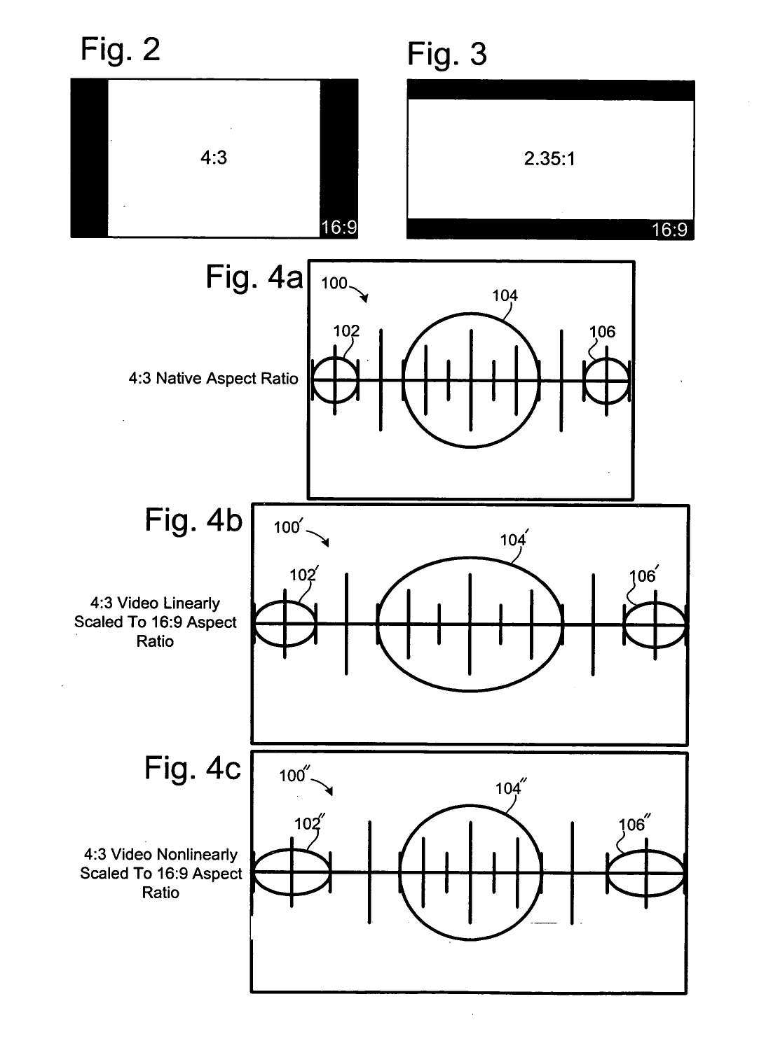

This disclosure relates to a system and method for displaying video on a device that is configured to natively display video of a different aspect ratio. While this can be accomplished with letterboxing, as shown in FIGS. 2 and 3, many viewers prefer to view images that use substantially the entire screen.

FIG. 4a shows a 4:3 screen that is displaying 4:3 formatted video. The 4:3 video includes an unscaled image 100. Image 100 is made up of a left circle 102, a middle circle 104, a right circle 106, a horizontal line intersecting all three circles, and a plurality of evenly spaced vertical lines that intersect the horizontal line. To occupy the entire screen of a device that has anything other than a 4:3 aspect ratio, image 100 must be scaled. FIGS. 4b and 4c show two different methods for scaling 4:3 video for display on a 16:9 video display device. Of course, the below described methods could be used to scale any aspect ratio to a different aspect ratio, and the 4:3 to 16:9 scaling that is described is not limiting.

In FIG. 4b, image 100′ is a linearly scaled version of image 100 from FIG. 4a. The 4:3 video image is horizontally stretched to fill a 16:9 screen. When an image is linearly scaled, as in FIG. 4b, the middle of the image is stretched to the same extent as the edges of the image. As can be seen in FIG. 4b, circles 102′, 104′, and 106′ appear much wider than the corresponding circles 102, 104, and 106 from FIG. 4a. Furthermore, because the image is linearly scaled, the relative degree of stretch to circles 102′ and 106′ is the same as the relative degree of stretch to circle 104′.

In FIG. 4c, image 100″ is a nonlinearly scaled version of image 100 from FIG. 4a. When an image is nonlinearly scaled, the amount of stretch can vary across the width and/or height of a screen. In the illustrated example, image 100″ is horizontally stretched by a greater amount near the edges of the image than near the interior of the image. As can be seen, circle 104″ is not stretched as much as circle 104′ from FIG. 4b. However, circles 102″ and 106″ are stretched more than the corresponding circles from FIG. 4b. Images can be nonlinearly scaled using a variety of different nonlinear scaling functions, and the example provided in FIG. 4c is in no way limiting.

As can be seen by comparing FIG. 4b and FIG. 4c, an image can look very different on the same screen depending on whether linear or nonlinear scaling is used. Attempts have been made to discover a single scaling function that works best with all types of images, but thus far, such attempts have not provided a satisfactory scaling function. Some images look best when scaled using a linear function, and other images look best when scaled using one of a plurality of different nonlinear scaling functions.

For example, text that spans the width of a display screen looks best when a linear scaling function is used. This way, the text looks consistent across the entire width of the screen. Furthermore, if the text is scrolling horizontally across the screen, such as in a stock ticker, the text will appear to be moving at a constant speed all the way across the screen. On the contrary, if a nonlinear scaling function is used, the text will appear to be wider near the edges of the screen than near the middle of the screen, and when horizontally scrolling, the text will appear to move faster near the edges of the screen than near the middle of the screen. Many viewers feel that this can be distracting and hard to read. Accordingly, text is a nonlimiting example of an image that may look better when scaled with a linear scaling function. In particular, static and/or scrolling content such as news tickers, subtitles, menus, and electronic program guides can be suitable for linear scaling.

Many viewers feel that using a linear scaling function can undesirably distort some types of images. As nonlimiting examples, people can appear to be unnaturally wide and/or objects such as balls, which should appear circular, can look like ovals. This can lead to a less enjoyable viewing experience. However, because most viewers focus on the middle of a screen, a nonlinear scaling function can mitigate, if not eliminate, these perceived problems. The objects in the middle of the screen, where the viewer is focused, are not stretched significantly when a nonlinear scaling function is used. The exaggerated stretching that is present at the edges of the screen can be less noticeable because that area is typically in the viewer's peripheral vision. Accordingly, many viewers feel that a nonlinear scaling function is more suitable for some images, including images that include people and other common objects near the middle of the screen.

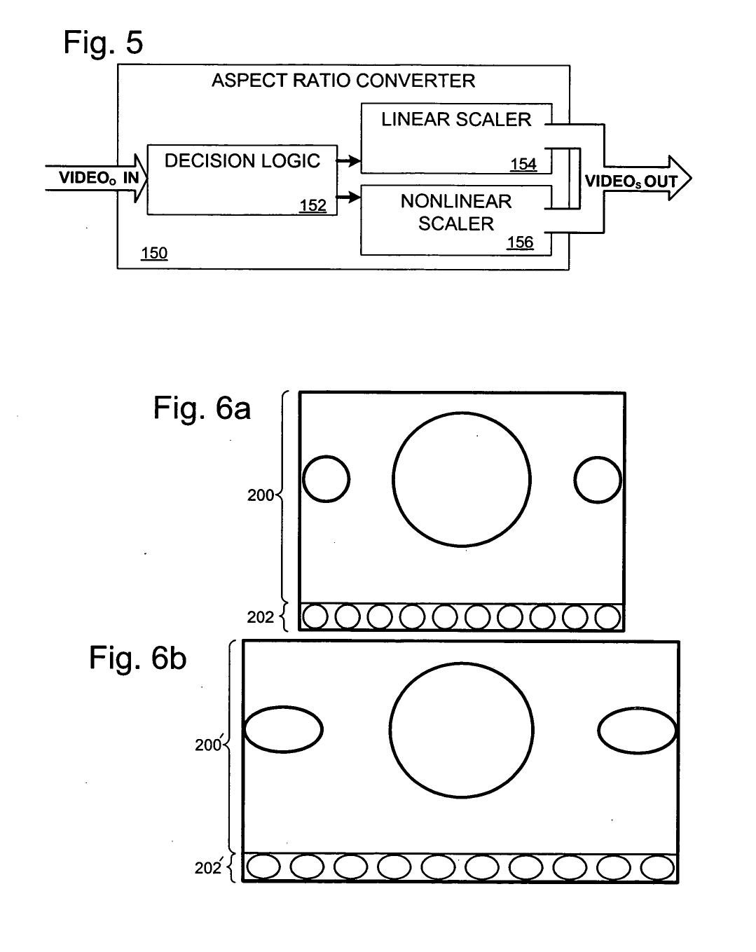

FIG. 5 schematically shows an aspect ratio converter 150 that is configured to scale a video image to a different aspect ratio. The converter can include volatile and/or nonvolatile memory, one or more processors, and/or various other components. In some embodiments, converter 150 can be implemented as a system on a chip, and in some embodiments, converter 150 can be one of several different constituent functional blocks of a system on a chip that is configured to execute a variety of video processing functions, as described in the following: U.S. Provisional Patent Application Ser. No. 60/537,082, filed Jan. 16, 2004; U.S. patent application Ser. No. 11/036,462, filed Jan. 13, 2005; U.S. patent application Ser. No. 11/183,227, filed Jul. 15, 2005; U.S. patent application Ser. No. 11/182,719, filed Jul. 15, 2005; U.S. patent application Ser. No. 11/182,728, filed Jul. 15, 2005; and U.S. patent application Ser. No. 11/182,721, filed Jul. 15, 2005. Each of the above listed documents is incorporated by reference for all purposes.

Converter 150 includes decision logic 152, linear scaler 154, and nonlinear scaler 156. Decision logic 152 can receive Videoₒ, which is formatted with an original aspect ratio. The decision logic is configured to determine if linear scaling, nonlinear scaling, or both is to be applied to Videoₒ. Depending on this determination, linear scaler 154 and/or nonlinear scaler 156 can operate on Videoₒ to output scaled video Videoₛ. Video₅ can be linearly scaled, nonlinearly scaled, or a combination of linearly and nonlinearly scaled depending on the determination of decision logic 152.

In some embodiments, aspect ratio converter 150 can be configured to linearly scale one or more regions of a video frame while one or more different regions of the same video frame are nonlinearly scaled. As an example, FIG. 6a shows an image that is suited for a combination of linear and nonlinear scaling. In particular, FIG. 6a shows a 4:3 aspect ratio image that includes a live action portion 200 (including three circles) and a scrolling text bar 202 (schematically represented as a horizontal row of circles). This video arrangement is commonly used for sports programming, where the live action sporting contest is displayed in a prominent portion of the screen, while scores, statistics, and/or other information is scrolled across the bottom of the screen. This arrangement is also common in news broadcasts, where a newscaster or live video footage is displayed in a prominent portion of the screen, while a stock ticker, weather information, sports scores, or other graphic or textual information is displayed at the bottom of the screen. In such video arrangements, many viewers prefer live action portion 200 nonlinearly scaled, and text bar 202 linearly scaled. Of course, numerous other video arrangements can benefit from combined linear and nonlinear scaling, and the illustrated arrangement is a nonlimiting example.

FIG. 6b shows the image from FIG. 6a scaled to a 16:9 aspect ratio. Live action portion 200′ is nonlinearly scaled so that the content of the image near the middle of the live action portion is horizontally stretched relatively less than the content of the image near the edges of the live action portion. This preserves the natural aspect ratio of objects near the middle of the image, where a viewer's focus is typically directed, while sacrificing the natural aspect ratio near the edges of the image, which typically are in the viewer's peripheral vision.

Text bar portion 202′ is linearly scaled so that it is horizontally stretched evenly across the width of the screen. In this manner, content in the text bar portion, such as text and/or graphics, looks the same near the edges as it does in the middle of the image. Furthermore, if the text is scrolling horizontally, it will scroll at a constant speed across the width of the screen.

Such a combined scaling approach in the same frame of video, can produce an overall image that is better than either linear scaling or nonlinear scaling can independently generate.

Furthermore, while some video content is suitable for combined linear and nonlinear scaling in the same video frame, some video content can be suitable for purely linear scaling in some frames and purely nonlinear scaling in other frames. For example, while watching a movie, many viewers believe that nonlinear scaling can produce a better image than linear scaling; but if the movie is stopped and a predominantly textual channel guide is invoked, many viewers believe that linear scaling can produce a better image than nonlinear scaling. Accordingly, it can be beneficial to switch from nonlinear scaling to linear scaling when a channel guide is called up, interrupting the video content. The same is true for numerous other scenarios in which the nature of the video changes substantially from one frame to the next. Of course, in addition to changing from nonlinear to linear scaling, there are also numerous scenarios when it is beneficial to change from linear to nonlinear scaling.

Turning back to FIG. 5, in some embodiments, decision logic 152 can be configured to partition a single frame of video into linear regions that are to be scaled using a linear scaling function and nonlinear regions that are to be scaled using a nonlinear scaling function. Alternatively, or in addition to, that type of partitioning, in some embodiments, decision logic 152 can be configured to partition a plurality of frames into linear frames that are to be scaled using a linear scaling function, nonlinear frames that are to be scaled using a nonlinear scaling function, and combined frames that are to be scaled using a linear scaling function on one or more regions while a nonlinear scaling function is used on one or more different regions.

In some embodiments, the decision logic can be configured to automatically detect which regions and/or frames are to be scaled using a linear scaling function and which regions and/or frames are to be scaled using a nonlinear scaling function. Such automatic detection can be made by analyzing input video and tagging selected frames and/or regions. For example, input video can be analyzed to determine if it includes static and/or scrolling content. As a nonlimiting example, text bars can be detected, for example, based on the location of the bar, based on the unmoving edge or border of the text bar relative to the rest of the frame, based on the unchanging color of the text bar, and/or any number of other indicators. The regions and/or frames that are determined to include static and/or scrolling content can be linearly scaled. Other regions and/or frames, such as live action sporting content and/or conventional movie content can be non-linearly scaled. Such content can be referred to as random content, and may not have the same tell-tale attributes as the static and/or scrolling content that is well suited for linear scaling (e.g., low motion, consistent motion in the same direction at the same speed, clearly defined edges, etc).

In some embodiments, the decision logic can be configured to receive user input to identify regions of a video frame that are to be scaled using a linear or nonlinear function. For example, a viewer may watch a channel that consistently has a text bar in a particular region of the video frame, and the viewer may prefer that the text bar be scaled using a linear function while the rest of the video frame is scaled using a nonlinear function. A video display system, of which aspect ratio converter 150 is a part, can include a user input mechanism so that the viewer can identify the text bar, so that decision logic 152 can cause the identified text bar to be scaled using a linear function.

In some embodiments, information other than purely video information can be used to facilitate detection of regions and/or frames that are to be scaled using a linear scaling function or a nonlinear scaling function. For example, a channel identifier can be used as a clue that a particular channel may include a text bar.

The above description provides a nonlimiting example of using a linear scaling function with a nonlinear scaling function. The present disclosure is not so limited. It should be understood that virtually any scaling function can be used with virtually any other scaling function without departing from the scope of this disclosure. For example, aspect ratio converter 150 can be configured to scale one region of a frame using a first nonlinear scaling function and to scale a different region of the same frame using a second nonlinear scaling function. Similarly, different nonlinear scaling functions can be used to scale different frames. As such, an aspect ratio converter can be configured with a plurality of different scalers that each scale video using a different scaling function, and/or an aspect ratio converter can include one or more scalers that can scale video using two or more different scaling functions.

Furthermore, it should be understood that while the above description provides a nonlimiting example of centering a nonlinear scaling function with a horizontal center of a display, this is not required. The aspect ratio converter can be configured to analyze video content and to center a nonlinear scaling function based on the analysis. For example, a foreground object may be detected, and a nonlinear scaling function can be centered on the detected foreground object even if it is near the edge of a video frame. Furthermore, an aspect ratio converter can be configured to dynamically adjust the center of a nonlinear scaling function. For example, the center may be moved to track the foreground object.

While the present embodiments and method implementations have been particularly shown and described, those skilled in the art will understand that many variations may be made therein without departing from the spirit and scope of the invention. The description should be understood to include all novel and non-obvious combinations of elements described herein, and claims may be presented in this or a later application to any novel and non-obvious combination of these elements. Where claims recite “a” or “a first” element or the equivalent thereof, such claims should be understood to include incorporation of one or more such elements, neither requiring nor excluding two or more such elements.

1. A video processing system, comprising:
a video input to receive input video having a native aspect ratio;
an aspect ratio converter to receive the input video and convert the native aspect ratio of the input video to a scaled aspect ratio, where the aspect ratio converter scales a first region of a frame of the input video using a first scaling function and scales a second region of the same frame using a second scaling function, different than the first scaling function; and
a video output to output video having the scaled aspect ratio.

2. The video processing system of claim 1, where the first scaling function is a nonlinear scaling function and the second scaling function is a linear scaling function.

3. The video processing system of claim 2, where a parameter of the nonlinear scaling function is dynamically changed based on changes to video content in the first region.

4. The video processing system of claim 3, where a center of the nonlinear scaling function is dynamically moved to track a foreground object in the first region.

5. The video processing system of claim 1, where at least one of the first scaling function and the second scaling function is dynamically changed responsive to changes in input video content.

6. The video processing system of claim 1, where the aspect ratio converter includes a content analyzer that defines the first region and the second region based on input video content.

7. The video processing system of claim 1, where the aspect ratio converter includes a content analyzer to differentiate content to be scaled using the first scaling function from content to be scaled using the second scaling function.

8. The video processing system of claim 1, where the aspect ratio converter includes a content analyzer to differentiate static or scrolling content from random content.

9. The video processing system of claim 1, where the aspect ratio converter scales static or scrolling content using a linear scaling function and scales random content using a nonlinear scaling function.

10. The video processing system of claim 1, where the first region extends from a left edge of the frame to a right edge of the frame.

11. The video processing system of claim 1, where the second region extends from a left edge of the frame to a right edge of the frame.

12. The video processing system of claim 1, where the second region includes a ticker bar.

13. A method of scaling an aspect ratio of a video stream, comprising:
analyzing content of the video stream to differentiate content having a first attribute from content having a second attribute;
defining a first region of the video stream around content having the first attribute;
defining a second region of the video stream around content having the second attribute;
scaling content in the first region using the first scaling function; and
scaling content in the second region using the second scaling function.

14. The method of claim 13, where analyzing content of the video stream includes identifying static or scrolling content.

15. The method of claim 13, where analyzing content of the video stream includes identifying a ticker bar.

16. The method of claim 13, where the first scaling function is a nonlinear scaling function and the second scaling function is a linear scaling function.

17. The method of claim 16, where scaling content in the first region includes dynamically changing a parameter of the first scaling function based on changes to video content in the first region.

18. The method of claim 17, where scaling content in the first region includes dynamically moving a center of the nonlinear scaling function to track a foreground object in the first region.

19. The method of claim 13, where defining a first region includes defining a first region extending from a left edge of a frame of the video stream to a right edge of the same frame, and where defining a second region includes defining a second region extending from the left edge of the same frame to the right edge of the same frame.

20. A system on a chip for performing a plurality of different image processing functions including scaling an aspect ratio of a video stream, the system on the chip comprising logic to:
analyze content of the video stream to differentiate content having a first attribute from content having a second attribute;
define a first region of the video stream around content having the first attribute;
define a second region of the video stream around content having the second attribute;
scale content in the first region using the first scaling function; and
scale content in the second region using the second scaling function.
